(19) United States
(12) Patent Application Publication
(10) Pub. No.: US 2010/0257040 A1
(43) Pub. Date: Oct. 7, 2010

(54) Multi-Merchant Reward Points Payment System

(75) Inventor: Vince Hunt, Carmel, CA (US)

Correspondence Address: Soquel Group, LLC, P.O. Box 691, Soquel, CA, 95073, US

(73) Assignee: SHOP.COM, Monterey, CA (US)

(21) Appl. No.: 12/727,627

(22) Filed: Mar. 19, 2010

Related U.S. Application Data
(60) Provisional application No. 61/161,693, filed on Mar. 19, 2009.

(51) Int. Cl. G06Q 30/00; G06Q 20/00; G06Q 40/00

(52) U.S. Cl. 705/14.17; 705/14.23

(57) ABSTRACT

A method of payment using reward points at a multi-merchant ecommerce website, comprising maintaining a merchandise database, enabling a shopper to interactively select one or more items from the merchandise database, thereby generating an aggregated selection of items for each merchant, enabling said shopper to purchase said one or more items using reward points from a reward program account managed by a reward program manager, electronically obtaining money from said reward program manager in exchange for said reward points, using an agreed to exchange rate to convert from points to money, and transferring the money into a funding account that is used to pay for purchases by the shopper.

### REFERENCE TO RELATED APPLICATIONS

This application claims benefit of U.S. Provisional Application No. 61/161,693, entitled Multi-Merchant Reward Points Payment System, filed on Mar. 19, 2009 by inventor Vince Hunt.

### FIELD OF THE INVENTION

The present invention relates to the redemption of reward points using electronic on-line commerce.

### BACKGROUND OF THE INVENTION

Reward programs, also referred to as loyalty programs, have been widely adopted as a way for retail companies to increase customer loyalty or retention. Reward programs are structured marketing efforts that reward, and therefore encourage, their members, also referred to as customers, to repeatedly purchase from the company offering the reward program. Many reward programs provide customers with a physical reward card, also referred to as a loyalty card, or a reward card. A physical reward card is typically a plastic or paper card, visually similar to a credit card or debit card, which identifies the card holder as a member in a reward program and provides a unique identifier for the customer. Presenting the reward card or other identifying information during a purchase transaction entitles the customer to a reward, generally either a discount on the current purchase, or an allotment of points that can be accumulated and later redeemed for merchandise and/or services. For example, for each dollar that an AMERICAN EXPRESS card holder spends using his/her AMERICAN EXPRESS card he/she earns one point that can be redeemed for free travel with participating airline frequent flyer programs, participating hotel frequent guest programs, car rental reward programs, or for merchandise from the AMERICAN EXPRESS catalog or website. As another example, AMERICAN AIRLINES enables its ADVANTAGE PROGRAM members to redeem their frequent flyer points for free travel and upgrades to a higher class of service. In addition, AMERICAN AIRLINES operates the “C. R. Smith Museum Gift Shop” that offers items of merchandise related to the C. R. Smith Aviation Museum.

One problem faced by reward programs is that accumulated reward points must be accounted for in the financial results reported by a company that offers a reward program, referred to as a reward program manager. This has the effect of depressing a reward program manager's financial performance. Therefore, a system or method that encourages reward program members to redeem their accumulated reward points in a timely manner would be beneficial.

Typically, a reward program manager creates an offering that includes selected items of merchandise and service that can be redeemed by their customers using accumulated reward points. This can be considered as a “closed loop” payment system in which the reward points can only be “redeemed” at the reward program manager's store or e-commerce website. One drawback of a closed-loop reward points payment system is that a reward program member is limited to making product selections from a single merchant's store or e-commerce website and may not find sufficient items of interest. In this case reward points may not be redeemed, or may be only partially redeemed in which case the reward program is not successful at inducing repeat purchasing behavior which is one of the outcomes typically desired by a reward program manager.

In contrast, a credit card payment system constitutes an “open loop” payment system because a credit card can be used with many merchants, i.e. their use is not restricted to a single merchant or to a small number of merchants. Therefore it would be advantageous for reward points to operate as an open loop payment system such that a reward program member could redeem his/her reward points for items of merchandise and service with a wide variety of merchants.

E-commerce technology enables shoppers to purchase diverse items of merchandise such as autos and clothes and diverse items of service such as travel and insurance on-line, from websites that act as virtual stores. E-commerce technology combines on-line catalog, browsing and search, inventory management, purchase and payment transactions, automated payment processing, and other components within a comprehensive e-commerce system. As e-commerce technology has matured, multi-merchant e-commerce sites that act as virtual shopping malls have developed. The virtual shopping mall provides a single integrated website, referred to herein as a multi-merchant website, where shoppers can purchase goods and services from a wide diversity of merchants.

Therefore it would be advantageous for a reward program member to be able to redeem his/her reward points for items of merchandise and service at a multi-merchant website. This would enable reward program members to use their accumulated reward points to select items of merchandise and/or service from a large selection of merchants. Such an approach would effectively convert a reward points program into open-loop payment system.

Implementing a multi-merchant reward points payment system for a plurality of merchants or for a multi-merchant website presents difficulties because each merchant requires a credit card or other form of payment, i.e. merchants do not typically accept reward points from airlines or other consumer companies as a means of payment. Thus it would be advantageous for a multi-merchant reward points payment system to accept reward points from customers as a means of payment for merchandise and services and in turn to pay merchants for said merchandise and services using a means of payment that they would typically accept such as a credit card.

### SUMMARY OF THE DESCRIPTION

The present invention concerns e-commerce including the purchase of products such as clothing, books, electronic equipment and vehicles, and services such as travel and insurance. More specifically, the present invention concerns a payment system that enables a consumer, henceforth referred to as a “shopper,” to pay for items of merchandise and service using accumulated rewards points. Aspects of the present invention provide methods for multi-merchant payment that enable a shopper to redeem reward points accumulated with one or more reward programs for a plurality of items of merchandise and services from a multi-merchant website. Aspects of the present invention provide methods for multi-merchant payment that enable a shopper to redeem reward points accumulated with one or more reward programs for a plurality of items of merchandise and services directly from merchants' e-commerce websites.

In one embodiment, the present invention enables a shopper to select items of merchandise and/or services at a multi-merchant e-commerce website and to pay for the items using reward points from a reward program. An e-commerce server exchanges the reward points from an electronic reward points system provided by the reward program manager for funds that are subsequently used to pay for products and/or services. The e-commerce server then aggregates the selected items according to merchant and issues orders to each merchant according to the aggregated selected items.

In one embodiment, the present invention enables a shopper to select items of merchandise and/or services directly from a plurality of merchants' e-commerce websites, where the merchants participate in a multi-merchant rewards points payment system, and to pay for the items using reward points from a reward program. An e-commerce server which provides the multi-merchant rewards points payment system exchanges the reward points from an electronic reward points system provided by the reward program manager for funds that are subsequently used to pay for products and/or services.

In one embodiment, the present invention establishes a temporary, or virtual, credit card account for a shopper, funded by the exchange of reward points for funds, that is then used to pay each merchant for purchases made by the shopper. The e-commerce server includes the virtual credit card account information with each order placed by the shopper. The merchant uses the virtual credit card information to obtain payment and ships the selected items to the recipient(s) designated in the order. It may be appreciated that from the perspective of the merchant the virtual credit card is indistinguishable from an ordinary credit card, i.e. the merchant processes the virtual credit card in the same way as an ordinary credit card.

One advantage of the present innovation is that enabling a shopper to pay for items of merchandise and/or service using reward points affords a wide selection of rewards that is likely to entice a shopper to redeem their accumulated reward points.

### BRIEF DESCRIPTION OF THE DRAWINGS

The present invention will be more fully understood and appreciated from the following detailed description, taken in conjunction with the drawings in which:

FIG. 1 is a simplified block diagram of a multi-merchant reward points payment system that enables a shopper to select items from a multi-merchant website and to pay for the items using reward points from a reward program, in accordance with an embodiment of the present invention;

FIG. 2A is an example shopper interface that enables a shopper to browse for merchandise and services from a multi-merchant website, in accordance with an embodiment of the present invention;

FIG. 2B is an example shopper interface that enables a shopper to pay for his/her selections using reward points and to provide shipping, payment and billing information for his/her order, in accordance with an embodiment of the present invention;

FIG. 2C is an example shopper interface that enables a shopper to pay for his/her selections partially using reward points, in accordance with an embodiment of the present invention;

FIG. 3A is a simplified diagram of an overall method performed by a multi-merchant reward points payment system, in accordance with an embodiment of the present invention;

FIG. 3B, a continuation of FIG. 3A, is a simplified diagram of the overall method performed by a multi-merchant reward points payment system, in accordance with an embodiment of the present invention.

FIG. 4 is a simplified diagram of a method for returning an item obtained from a multi-merchant reward points payment system, in accordance with an embodiment of the present invention;

FIG. 5 is a simplified block diagram of a multi-merchant reward points payment system that enables shoppers to purchase items using reward points and/or credit cards and for an e-commerce server to issue orders to merchants using credit cards, in accordance with an embodiment of the present invention;

FIG. 6 is a simplified block diagram that describes the functions performed by an e-commerce server that supports a multi-merchant reward points payment system, in accordance with an embodiment of the present invention;

FIG. 7 is a simplified block diagram of various components of the e-commerce server illustrated in FIG. 6, in accordance with an embodiment of the present invention;

FIG. 8 is a simplified block diagram of an example client-server architecture for implementing a multi-merchant reward points payment system, in accordance with an embodiment of the present invention; and

FIG. 9 is a simplified block diagram of a multi-merchant reward points payment system that enables a shopper to select items from participating merchant websites and to pay for the items using reward points from a reward program, in accordance with an embodiment of the present invention.

### DETAILED DESCRIPTION

Aspects of the present invention concern inter alia a multi-merchant reward points payment system, which enables a shopper to use reward points to purchase items of merchandise and/or service.

As used herein the following terms have the meaning given below:

Shopper—means an individual using a personal computer or mobile device to shop online, i.e. from an ecommerce website. A shopper uses a Web browser such as Mozilla Firefox or Microsoft Internet Explorer running on a client computer or a mobile device that provide Web access to websites including e-commerce websites. Examples of mobile devices that provide Web access include the APPLE IPHONE provided by Apple Computer of Cupertino Calif., the BLACKBERRY provided by Research in Motion of Waterloo, Ontario, and the TREO provided by Palm. Inc. of Sunnyvale, Calif. Unless otherwise specified, the term shopper as used herein refers to both the individual and their client computer or mobile device, i.e. the shopper's client computer or mobile device is not referred to separately.

Recipient—means an individual or individuals, company or organization that receives items of merchandise and/or service purchased using a multi-merchant reward points payment system.

Reward program—means a program offered by a reward program manager that enables shoppers to accumulate reward points and enables shoppers to redeem their reward points for items of merchandise and/or service.

Reward program manager—means a company that offers and manages a reward program.

Reward points—reward points are awarded to a shopper by a reward program when they use their reward program account in conjunction with a qualifying purchase.

Reward program account—means an account managed by a reward program manager for a shopper in which the shopper can accumulate reward points and redeem reward points for items of merchandise and/or service.

Item—means an item of merchandise such as an auto or a book or an item of service such as insurance for a motorcycle.

Multi-merchant website—means a single website that enables a shopper to inter alia search for, browse, select, and purchase items from a plurality of merchants. A multi-merchant website functions as an online shopping mall.

Merchant—means an individual or company that offers items for sale from a website. In the context of the present invention, a merchant participates in a multi-merchant reward points payment system either directly or by being part of a multi-merchant website that itself uses a multi-merchant reward points payment system. Further, in the present invention, said merchants are the “merchants of record” for e-commerce credit card transactions, meaning that merchants charge shoppers' credit cards, or virtual credit cards, directly.

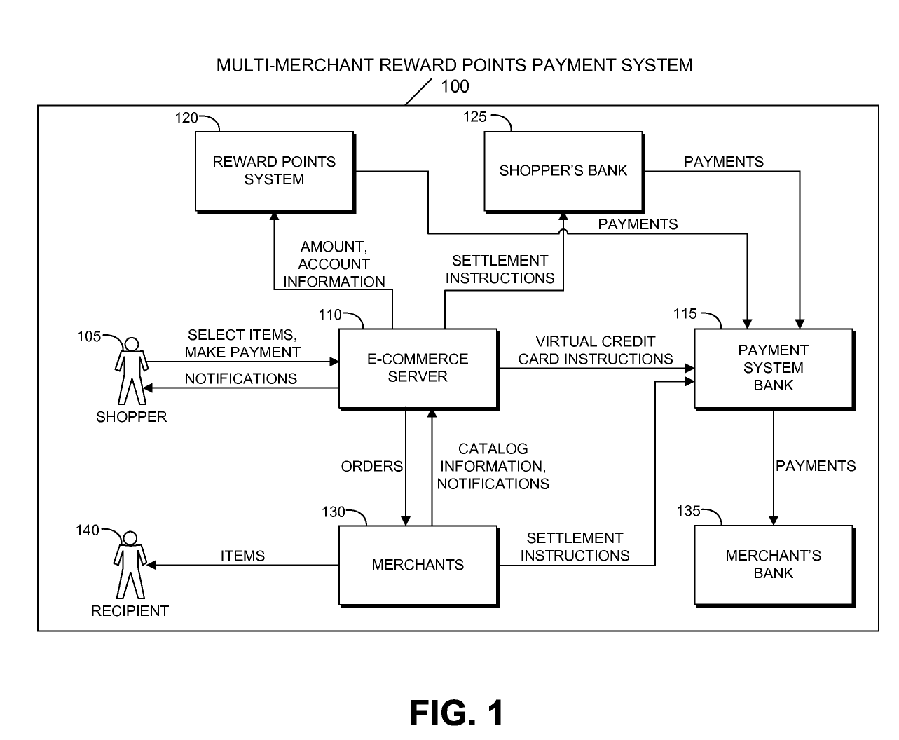

Reference is now made to FIG. 1, which is a simplified block diagram of a multi-merchant reward points payment system that enables a shopper to select items from a multi-merchant website and to pay for the items using reward points from a reward program, in accordance with an embodiment of the present invention. Shown in FIG. 1 is an e-commerce server 110 which interacts with at least one shopper 105, at least one payment system bank 115, at least one reward points system 120, a plurality of merchants 130, and at least one shopper's bank 125.

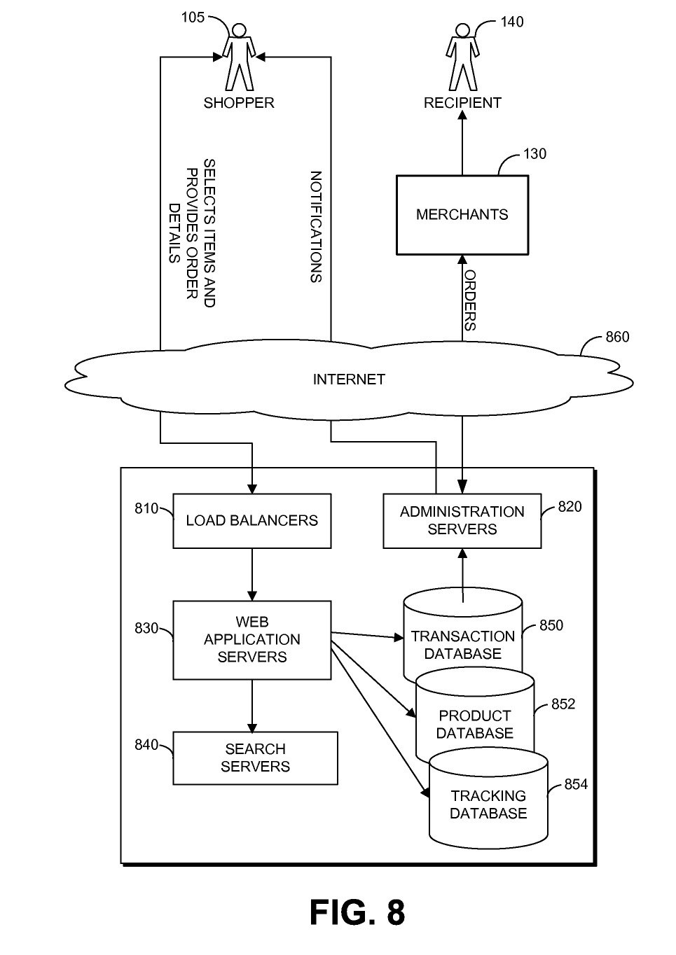

E-commerce server 110 is a server computer system that enables merchants 130 to publish and showcase their catalogs of merchandise and services on a multi-merchant website. E-commerce server 110 is represented as a single computer in FIG. 1 for the sake of clarity. However, e-commerce server 110 may be embodied in a single computer, or distributed as multiple computers communicating with one another. In the embodiment shown in FIG. 8, for example, e-commerce server 110 includes multiple Web application servers, administration servers, search servers, and load balancers.

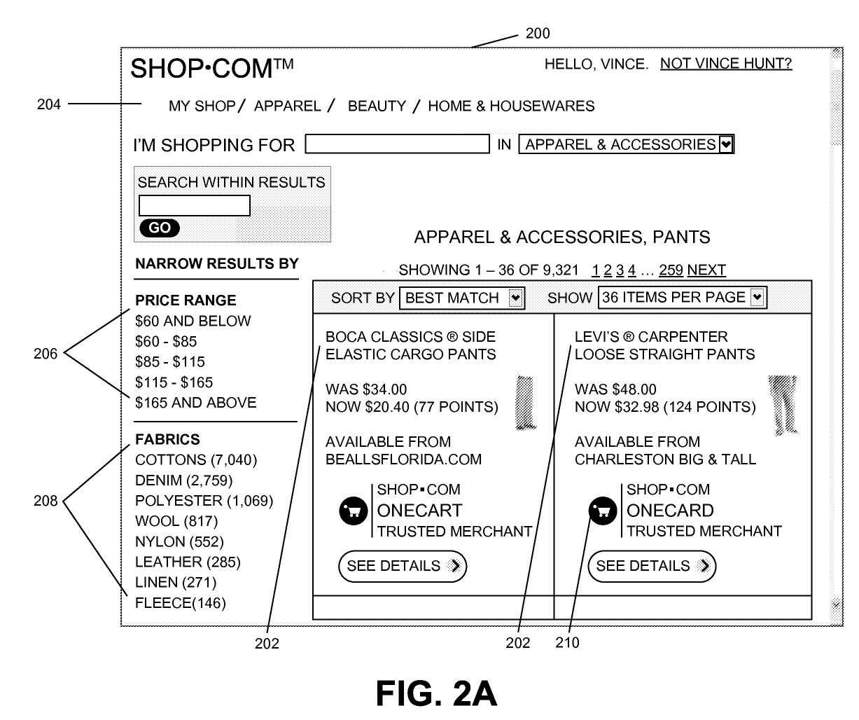

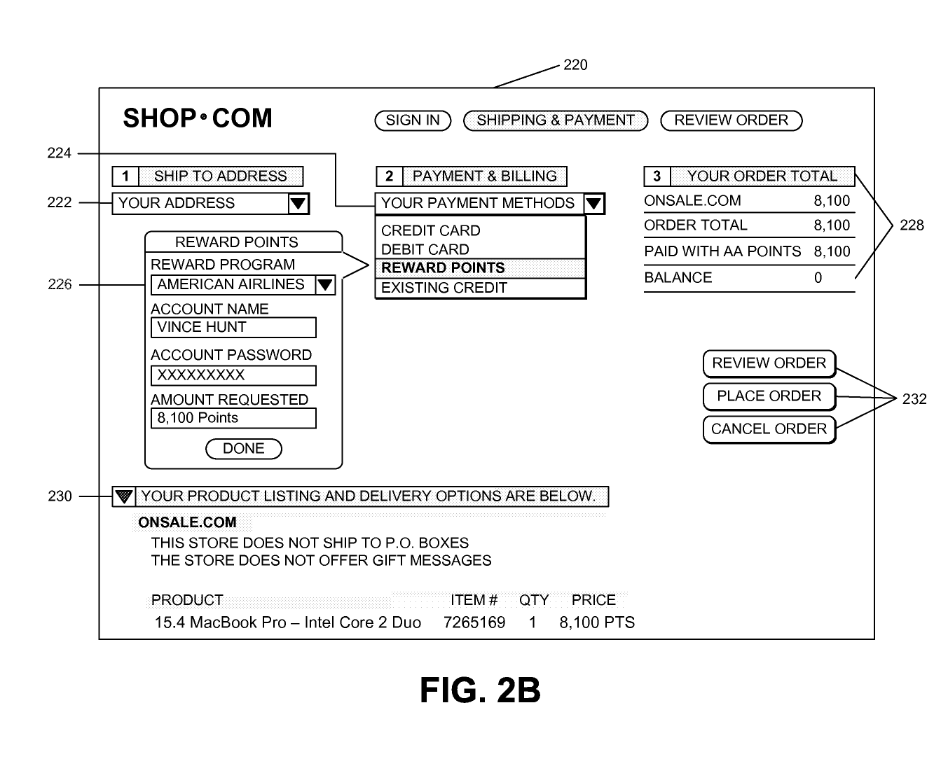

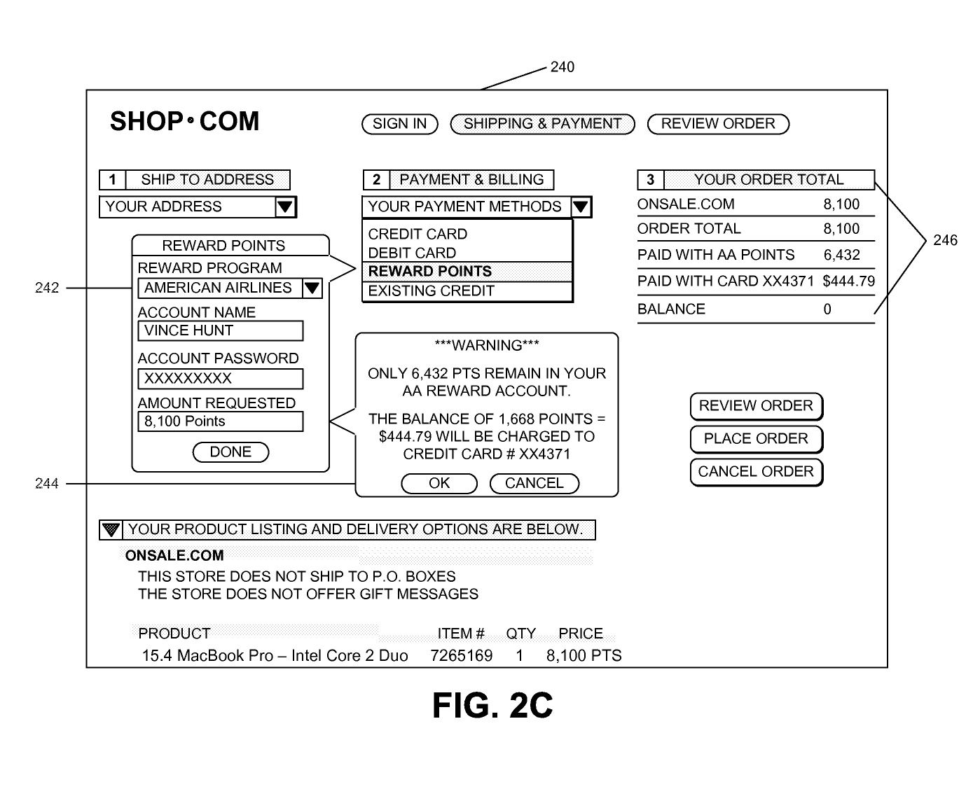

In accordance with an embodiment of the present invention, shopper 105 visits the multi-merchant website provided by e-commerce server 110 and shops, i.e. selects one or more items. An example of a user interface that e-commerce server 110 might provide to enable shopper 105 to shop is described with reference to FIG. 2A. Said items are provided by merchants 130 that participate in the multi-merchant website by providing catalog information about their items to e-commerce server 110. Generally, shopper 105 registers with e-commerce server 110 by providing basic information including inter alia name, physical address, e-mail address, method of payment information, shipping information, and personal information that may be used for authenticating the shopper.

After selecting one or more items, shopper 105 finalizes his/her order by checking out. During the checkout process, shopper 105 provides shipping and payment information and may review the order details. When providing payment information, shopper 105 specifies his/her preferred method of payment which includes reward points from a reward program account, credit card and debit card. An example shopper interface that enables shopper 105 to provide shipping, payment and billing information is described with respect to FIG. 2B.

If shopper 105 selects a reward points payment method, then e-commerce server 110 uses the supplied reward program account information to obtain payment from reward points system 120 operated by its reward program manager. Typically, reward points system 120 provides a real-time Web interface that enables e-commerce server 110 to request that reward points system 120 redeem reward points accumulated by shopper 105 and held in his/her reward program account. In one embodiment, the Web interface provided by reward points system 120 uses a a remote procedure call (RPC) mechanism such as that provided by Web service as defined by the World Wide Web Consortium (W3C). In this embodiment, e-commerce server 110 requests redemption by electronically transmitting a redemption request message to reward points system 120. Then, reward points system 120 performs the redemption operation and responds to the redemption request by sending a redemption response message to e-commerce server 110. The redemption request message includes information about the reward program account to be used and the number of points requested. The redemption response message provides the status of the redemption operation. Further information about Web services can be found at http://www.w3.org/.

To perform the redemption operation, reward points system 120 debits the shopper's reward account the requested number of reward points. The reward points are then converted to a payment amount using a conversion or exchange rate that has been previously agreed to by the reward program manager and the operator of the reward points payment system. Then, reward points system 120 electronically transfers said payment amount into a “card funding account” specified in the redemption request message. The card funding account, located in payment system bank 115, is used to pay merchants 130 for orders placed by shopper 105.

Shopper 105 may use multiple payment methods to pay for an order. For example, shopper 105 may pay for one part of an order using reward points and the remaining part using a credit card. Also, it may occur that the reward program account for shopper 105 does not contain sufficient reward points to pay for the full order. In this case, e-commerce server 110 prompts shopper 105 to pay the balance of the order, i.e the portion not covered by his/her reward points using an additional payment method. Shopper 105 may select another reward program account as the method of payment for the balance. Alternatively, shopper 105 may select a credit card as the method of payment for the balance. In this case, e-commerce server 110 sends credit card settlement instructions to a shopper's bank 125. Shopper's bank 125 then makes the requested payment into the card funding account for shopper 105 located in payment system bank 115. It may be appreciated by one skilled in the art that payment methods in addition to reward points and credit card including inter alia debit card and electronic funds transfer systems such as PAYPAL may be provided by reward points payment system 100. PAYPAL is an online payment system owned and operated by eBay, Inc. of San Jose, Calif.

When payment system bank 115 first receives a payment into the card funding account for shopper 105, e-commerce server 110 establishes and loads a “virtual credit card account” for shopper 105 with the amount deposited. It may be appreciated that such payment may be a funds transfer from reward points system 120 as a result of shopper 105 choosing reward points as the method of payment; or it may be the result of shopper 105 choosing a different method of payment such as credit card. If a virtual credit card account for shopper 105 already exists, e-commerce server 110 reloads the account with the amount of the deposit. The virtual credit card account acts like a standard credit card account in that it is established, funded, has a unique credit card number, and is guaranteed and operated by a bank. The amount credited to the virtual credit card acts a limit against which purchases can be made and fees may be assessed. The act of establishing an initial amount is referred to as “loading” the virtual credit card account. The act of adding additional funds to the account is referred to as “reloading” the virtual credit card account. The key differences between a virtual credit card and a standard credit card are that (1) it is managed by e-commerce server 110 and not by shopper 105, (2) it is terminated when the balance is used up, i.e. it is temporary in nature, and (3) no physical credit card is ever issued. Establishing and loading a virtual credit card are two of the virtual credit card instructions that e-commerce server 110 may issue to payment system bank 115. Other instructions include reloading and closing a virtual credit card account.

The actual credit card number is stored and managed by e-commerce server 110. E-commerce server 105 provides the credit card number to merchants 130 to pay for purchases made by shopper 105 on the multi-merchant website.

In one embodiment, e-commerce server 110 generates a proxy number that it presents to shopper 105. In this embodiment, shopper 105 may use the proxy number on websites that participate in reward points payment system 100. Such websites, in turn, supply the proxy number to e-commerce server 110 and in return obtain the virtual credit card number that they use to obtain payment for purchases made by shopper 105.

In another embodiment, e-commerce server 110 provides the actual credit card number to shopper 105 to use for making purchases. Such purchases are unrestricted since the credit card number is fully operational, albeit with a limited amount of funds to draw on, i.e. the amount of funds in the card funding account.

When the checkout process is complete, e-commerce server 110 aggregates the selected items according to merchant and issues orders to each merchant 130 according to the aggregated selected items. E-commerce server 110 includes the virtual credit card account information with the order.

Merchant 130 uses the virtual credit card information to request authorization and settlement for their portion of the order from payment system bank 115. Payment system bank 115 authorizes and settles the credit card transaction and payment is made to a designated account in a merchant's bank 135. Each merchant 130 ships the selected items to each recipient 140 as indicated in the order. Shopper 105 may be a recipient of an item shipped by merchant 130, but in fact an item may be shipped to anyone. Recipient 140 does not have to be a registered shopper.

Reference is now made to FIG. 2A which is an example shopper interface that enables a shopper to browse for merchandise and services from a multi-merchant website, in accordance with an embodiment of the present invention. Typically, shopper 105 begins browsing from a home page, which is a web page that displays a list of categories of merchandise and services. On the home page, shopper 105 may inter alia select a category from the list of categories or search entering keywords into a search box. Shopper interface 200 appears after shopper 105 selects “Apparel and Accessories” from the home page and then selects the subcategory “Men's Pants.” Two products 202 are visible in shopper interface 200: a “BOCA CLASSICS SIDE ELASTIC CARGO PANTS”, and a “LEVI CARPENTER LOOSE STRAIGHT PANTS”. Each product is supplied by a different merchant 130, e.g. BOCA CLASSICS CARGO PANTS are available from BeallsFlorida.com and LEVI CARPENTER LOOSE STRAIGHT PANTS are available from Charleston Big & Tall. The price of each product is displayed in both dollars ($) and reward points. Shopper 105 may click on the photo or product name to obtain additional information about the product. Shopper 105 may inter alia click on a different top level menu category 204 which includes “my shop”, “apparel”, “beauty”, “home & housewares”, or select a price range 206, or a fabric 208. At any time shopper 105 may click on a shopping cart control 210 which adds the item to his/her shopping card and navigates to the shopping card where shopper 105 may inter alia change the quantity of an item, delete an item, or proceed with check out.

Reference is now made to FIG. 2B which is an example shopper interface that enables a shopper to pay for his/her selections using reward points and to provide shipping, payment and billing information for his/her order, in accordance with an embodiment of the present invention. Typically, every web page provided by the multi-merchant website includes a navigation control that enables shopper 105 to visit his/her shopping cart. Several of the capabilities provided by a shopping cart are shown in example shopper interface 220. Shopper 105 may select a ship to address from a menu of ship to addresses 222 that he/she has previously supplied. Alternatively, shopper 105 may add a new ship to address. Shopper 105 may select a payment method using a payment method menu 224. If shopper 105 selects “Reward Points” as the payment method then a reward points dialog box 226 appears that enables shopper 105 to select a reward program account that he/she wishes to use to pay for the items he/she has added to the shopping cart. Shopper 105 is further prompted in reward points dialog box 226 to provide his/her reward program account name and reward program account password. The amount of the order, in reward points, appears in an amount requested field within reward points dialog box 226. Shopper 105 may change the amount requested. If he/she changes the amount requested to be less than the order total then he/she must subsequently provide another method of payment to pay the remaining balance. If he/she requests an amount greater than the order total then his/her account will be credited with the difference.

The items in the shopping cart are shown in an order total box 228 aggregated by merchant. A product listing section 230 lists the items selected aggregated by merchant together with any special information for the merchant including inter alia shipping and delivery options. A set of controls 232 enables shopper 105 to review the order, place the order, or cancel the order.

Reference is now made to FIG. 2C which is an example shopper interface that enables a shopper to pay for his/her selections partially using reward points, in accordance with an embodiment of the present invention. As in FIG. 2B, shopper 105 selects AMERICAN AIRLINES from a pulldown menu in reward points dialog box 242 that lists available reward programs. Shopper 105 attempts to pay the entire amount of 8100 reward points from his/her AMERICAN AIRLINES reward program account. However, when shopper 105 clicks on “Done” in reward points dialog box 242, e-commerce server 110 displays a message indicating that there are not sufficient points to pay the entire amount and that the difference between the points available in the AMERICAN AIRLINES reward program account and the amount of the order will be paid using a credit card. Typically, this is a credit card that shopper 105 has previously used and has agreed to allow e-commerce server 110 to store the necessary details for later use. Order total box 246 indicates the amount of the order, the amount paid using AMERICAN AIRLINE reward points and the amount paid using the selected credit card.

It may be appreciated by one skilled in the art that user interface 240 presents one method that shopper 105 may use two different payment methods and that the present invention may equally employ other user interfaces and other methods to enable shopper 105 to flexibly use multiple payment methods, including reward points, to pay for orders.

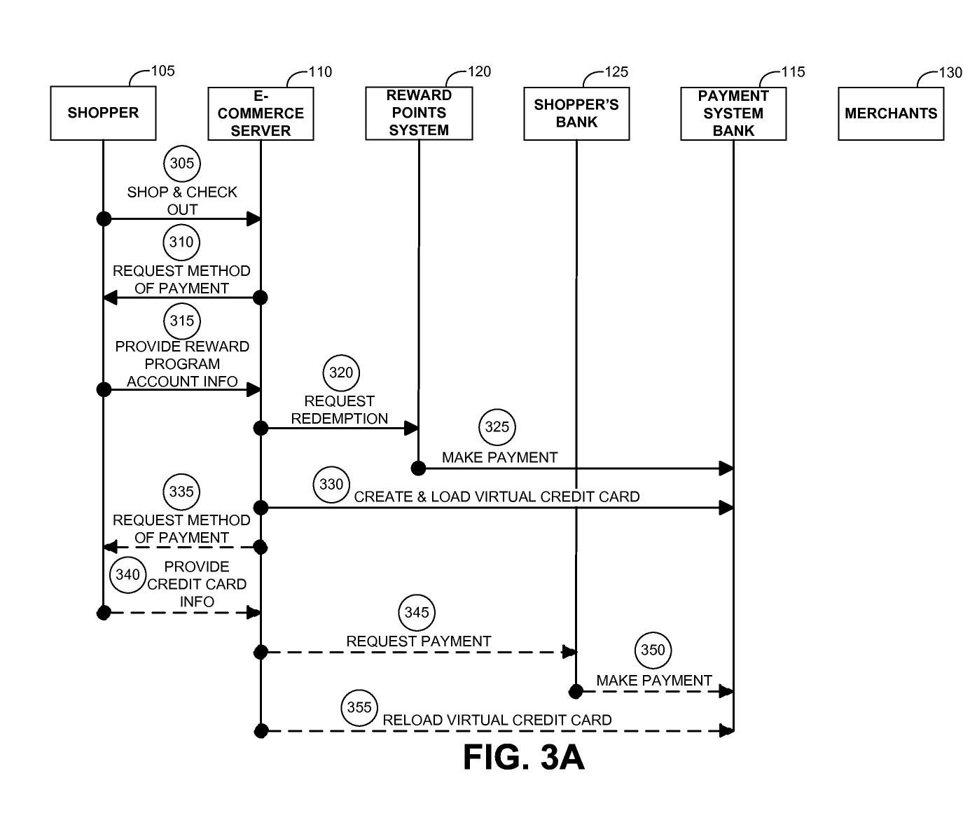

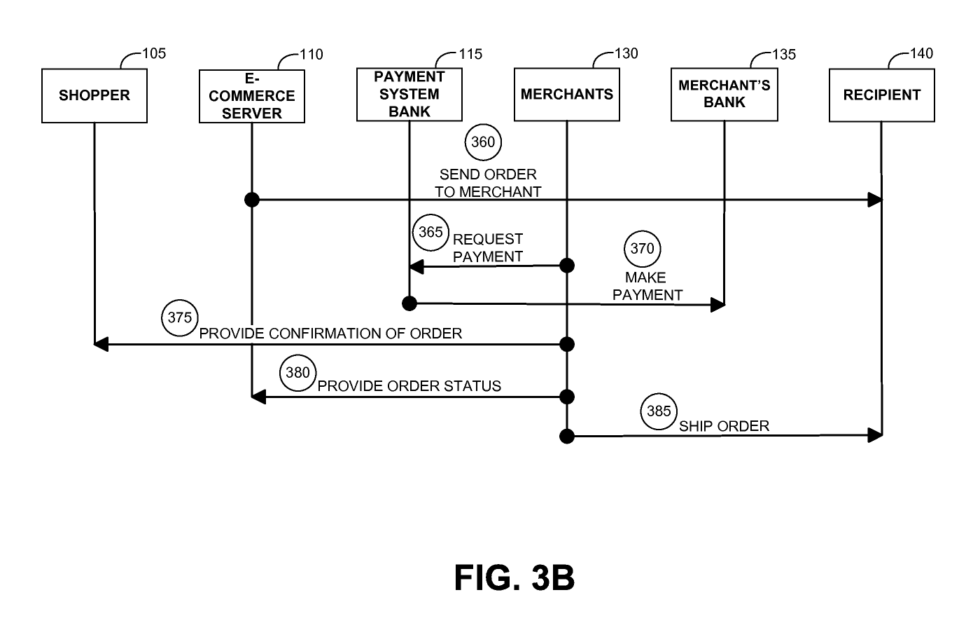

Reference is now made to FIG. 3A which is a simplified diagram of an overall method performed by a multi-merchant reward points payment system, in accordance with an embodiment of the present invention. At step 305 shopper 105 shops for items of merchandise and/or service at the multi-merchant ecommerce website and selects the checkout function. In one embodiment, if shopper 105 is not yet a registered shopper he/she is required to register and establish an account with e-commerce server 110 at this point.

At step 310 e-commerce server 110 prompts shopper 105 to provide information including method of payment. At step 315 shopper 105 selects “REWARD POINTS” as his/her method of payment, provides the requested reward program account information and indicates the number of points requested. At step 320 e-commerce server sends a redemption request message to reward points system 120 to redeem the number of reward points requested at step 315. At step 325 reward points system 120 makes a payment by electronically transferring the requested amount, based on the agreed to reward points to currency exchange rate, to the card funding account for shopper 105 in payment system bank 115.

At step 330 e-commerce server 110 issues instructions to payment system bank 115 to create a virtual credit card account and load it with the amount just paid by reward points system 120. In this step, e-commerce server 110 stores the virtual credit card account information into a shopper record for shopper 105. The shopper record is a database record that stores information concerning shopper 105.

Steps 335-355 are only performed if the payment made by reward points system 120 is less than the amount of the order. This may happen if there are insufficient reward points in the reward program account of shopper 105 to cover the full amount of the order or if shopper 105 requested a number of points at step 315 that is less than the number of points required to pay for the entire order. At Step 335 shopper 105 is informed that the amount of money paid by reward points system 120 at step 325 is insufficient to cover the order and is prompted to select a supplemental method of payment to pay the remaining amount. In one embodiment, shopper 105 may select any method of payment that has not previously failed to generate the full amount of money or points requested. For example, shopper 105 may select a credit card, different reward program, or PAYPAL as a supplemental method of payment.

At step 340, shopper 105 selects credit card as the method of payment and provides the necessary credit card information including the name of the account holder, account number and amount. Then, at step 345 e-commerce server 110 requests payment by shopper's bank 125 into the previously established card funding account for shopper 105 residing in payment system bank 115. For purposes of clarification, shopper's bank 125 is the issuing bank for the credit card provided by shopper 105 for the transaction.

At step 350 shopper's bank makes a payment of the requested amount which results in a deposit into the card funding account in payment system bank 115 for shopper 105. Next, at step 355 e-commerce server 110 reloads, or adds to, the virtual credit card account the amount deposited into the card funding account.

Reference is now made to FIG. 3B, a continuation of FIG. 3A, which is a simplified diagram of an overall method performed by a multi-merchant reward points payment system, in accordance with an embodiment of the present invention. At step 360 e-commerce server 110 aggregates the selected items according to merchant and sends orders to each merchant 130 from which an item has been ordered. E-commerce server 110 sends the virtual credit card information with each order.

At step 365 merchant 130 issues a request for payment for the order from payment system bank 115 which is the issuing bank for the virtual credit card. At step 370 payment system bank 115 makes a payment to a designated account in merchant's bank 135. At step 375 merchant 130 provides confirmation of the order to shopper 105. At step 380 merchant 130 provides the status of the order to e-commerce server 110. Finally, at step 385, merchant 130 ships the item(s) specified in the order to recipient 140. It should be noted that there may be more than one recipient 140. Depending on the number of recipients, the size of the items to be shipped, and the availability and the physical location of the items, merchant 130 may be required to perform more than one shipment.

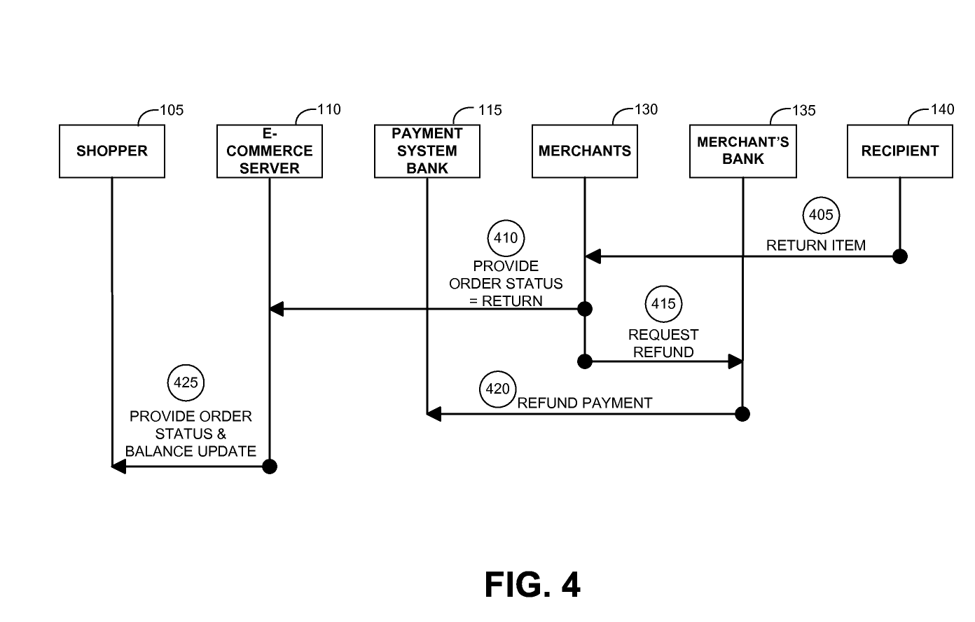

Reference is now made to FIG. 4 which is a simplified diagram of a method for returning an item obtained from a multi-merchant reward points payment system, in accordance with an embodiment of the present invention. This method concerns the return of an item ordered by shopper 105 and shipped to a recipient 140. As previously discussed, recipient 140 may be any individual, regardless of whether said individual is a registered shopper. Further recipient 140 may be the same individual as shopper 105 in the event that shopper 105 purchases an item for themselves and wishes to return it. At step 405 recipient 140 returns the item to merchant 130. In one embodiment, to perform the return recipient 140 calls or emails merchant 130 prior to actually shipping back the item. In turn, merchant 130 provides a return merchandise authorization (RMA) number together with shipping instructions. Recipient 140 then re-packages and ship the item to merchant 130, providing said RMA number on or inside the package.

At step 410 merchant 130 provides e-commerce server 110 an updated order status indicating that the item has been returned. Then, at step 415 merchant 130 issues a request to merchant's bank 135 to refund the amount that was paid to merchant 130 for the received items. At step 420 merchant's bank 135 repays the amount of the item returned to the card funding account in payment system bank 115. Merchant's bank 135 uses the virtual credit card that was supplied with the order to perform the refund. As previously discussed, the virtual credit card behaves like a standard credit card, thus returning is a standard credit card operation. In one embodiment, merchant 130 may reduce the credited amount by inter alia a restocking or shipping fee.

Finally, at step 425, e-commerce server 110 updates the shopper record to reflect the new balance in the virtual credit card account and notifies shopper 105 of the status of the returned order indicating the new balance in his/her account. In this embodiment, any reward points used to pay for the order have been converted to funds and remain in the card funding account of shopper 105. In another embodiment, any reward points used to pay for the order can be restored to the reward program account of shopper 105.

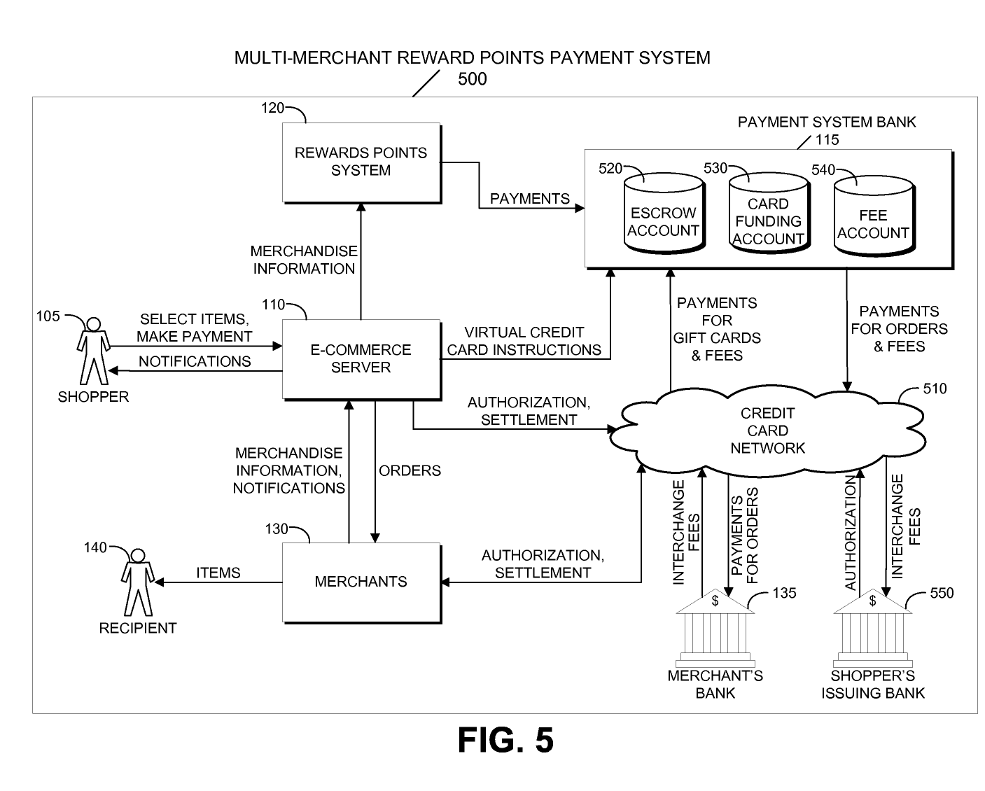

Reference is now made to FIG. 5 which is a simplified block diagram of a multi-merchant reward points payment system that enables shoppers to purchase items using reward points and/or credit cards and for an e-commerce server to issue orders to merchants using credit cards, in accordance with an embodiment of the present invention. FIG. 5 illustrates one embodiment of multi-merchant reward points payment system 100, described with reference to FIG. 1, in which payments to merchants are made using credit cards such as VISA, MASTERCARD, AMERICAN EXPRESS and DISCOVER. Such credit card transactions are carried out across a credit card network 510.

In the embodiment illustrated in FIG. 5, shopper 105 uses reward points as his/her means of payment for items he/she has selected from the multi-merchant e-commerce website provided by e-commerce server 110. Shopper 105 provides the requested reward program account information as discussed with reference to FIG. 2B.

E-commerce server 110 uses the reward program account information to request that reward points system 120 make a payment to a designated card funding account 530 in payment system bank 115. Reward points system 120 may make a direct electronic funds transfer into card funding account 530; alternatively, reward points system 120 may pay using a credit card. Additional mechanics of credit card payments are discussed below.

As previously described, after payment has been successfully processed, e-commerce server 110 issues instructions to payment system bank 115 to establish and load a virtual credit card account. It should be noted that payment system bank 115 is the issuing bank for the virtual credit card. Thus, any interchange fees collected by credit card network 510 for use of the virtual credit card will be paid to payment system bank 115. In one embodiment, payment system bank 115 shares interchange fees collected for use of virtual credit cards with the operator of multi-merchant payment system 500. Said shared interchange fees are paid into a designated fee account 540.

The virtual credit card account allows it to also act an “open-loop” payment method with respect to merchants 130 since the virtual credit card is used to pay a plurality of merchants 130.

It may be appreciated that e-commerce server 110 may work in conjunction with commercial services such as those provided by eFunds and Metavante to establish and manage a virtual credit card account. eFunds Corporation is based in Scottsdale, Ariz. Metavante Corporation is headquartered in Milwaukee, Wis., and is the principal subsidiary of Metavante Technologies, Inc.

As previously described, e-commerce server 110 issues an order to each merchant 130 from which shopper 105 selected an item. The order includes the virtual credit card information for the shopper 105 account managed by e-commerce server 110. As with any other credit card transaction, merchant 130 uses the virtual credit card information to request authorization and settlement from credit card network 510. Using credit card network 510, payment system bank 115 authorizes and settles the transaction, crediting the amount to a specified account in a merchant's bank 135. The amount credited is the amount of the items purchased minus an interchange fee. Credit card network 510 pays the interchange fee to payment system bank 115 which is the issuing bank for the virtual credit card that was used to pay merchant 130. By mutual agreement, payment system bank 115 pays a share of interchange fees that it collects for use of virtual credit cards into fee account 540.

For purposes of clarity, credit card network 510 includes a credit card processor for e-commerce server 110, a credit card processor for merchant 130 and a credit card network supported by each credit card processor. To further clarify, when a merchant receives an order from e-commerce server 110 and accepts a virtual credit card as payment for the order, the virtual credit card number, the amount, and an unique merchant identification code travel over their respective credit card processor's computer network. The credit card processor can either be a bank or a company that provides credit card processing services. From the processor's network the transaction goes to a credit card computer network. The electronic transaction travels across the network to the bank that actually issued the card, commonly referred to as the “issuing bank”. The issuing bank checks the account and verifies that there is adequate credit in the virtual credit card account to cover the purchase. The issuing bank then sends the merchant an authorization over the network. At this point, the sale is complete. Next, the transaction is “settled.” Settlement of a transaction occurs when the issuing bank for the virtual credit card debits the corresponding card funding account and makes appropriate payments. The merchant in turn credits the merchant's bank account for the transaction amount, minus its fees for the transaction. Those fees are allocated between the issuing bank and the credit card network itself.

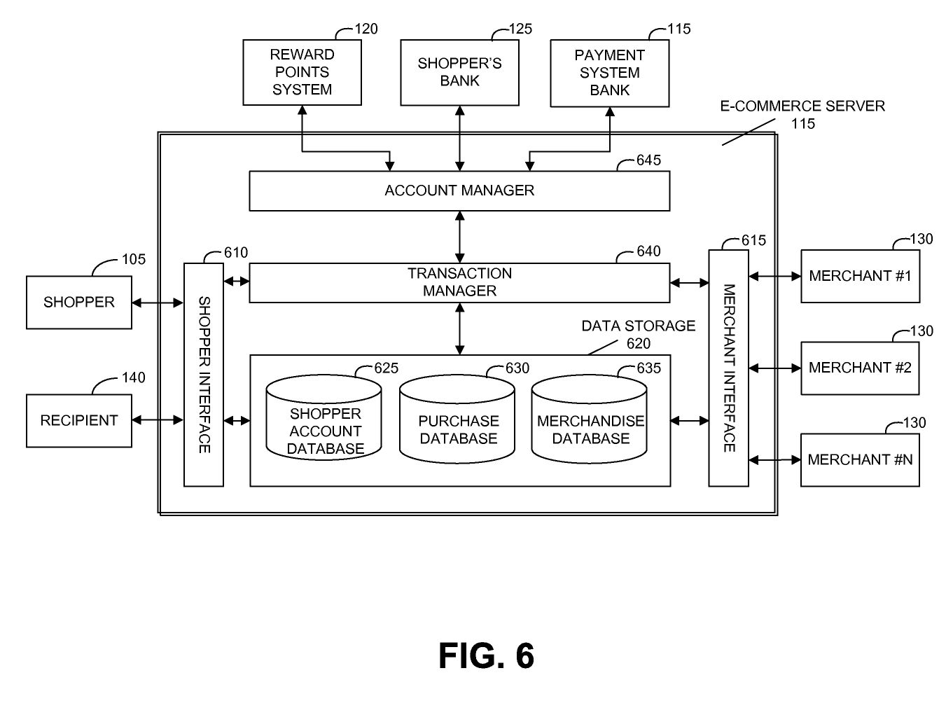

Reference is now made to FIG. 6, which is a simplified block diagram that describes the functions performed by an e-commerce server that supports a multi-merchant reward points payment system, in accordance with an embodiment of the present invention. Shoppers interact with the website via a shopper interface 610, merchants interact with the website via a merchant interface 615, and e-commerce server 110 interacts with reward points system 120, shopper's bank 125 and payment system bank 115 via an account manager 645.

A data storage 620 stores a shopper account database 625, a purchase database 630 and a merchandise database 635. Data storage 620 is a logical storage system typically implemented using a relational database manager; it may be implemented using a range of commercially available physical storage devices.

Shopper account database 625 stores a shopper record for each shopper 105. The shopper record maintains the shopper account information. Each record includes (i) a shopper name, (ii) a shopper identifier that uniquely identifies the shopper and the shopper account, (iii) billing and shipping address for the shopper, and (iv) means of payment information for each means of payment supplied by the shopper, including credit card information and reward program account information, (v) the balance of the shopper account, and (vi) virtual credit card information for the shopper account.

Purchase database 630 stores a purchase record for each order made by shopper 105. The purchase record includes (i) a unique identifier for the order, referred to as an order id, (i) a shopper identifier that uniquely identifies the shopper, (ii) the date and time of the order, (iii) means of payment information including any transaction information such as a credit card authorization number, (iv) the amount of the order, (v) the items ordered and the price of each, (vi) the name and contact information of each recipient, (viii) an optional message from shopper 105 to each recipient 140.

Merchandise database 635 stores a record for each item of merchandise or service published by any merchant 130. Each record includes (i) a stock keeping unit (SKU) for the item, (ii) a description of the item, (iii) a description of product options for the item, (iv) a price of the item with and without the product options, (v) shipping information for the item including shipping cost, and (vi) the merchant who provides the item. The SKU functions as a unique identifier for the item. The description generally includes one or more images of the item and a text description.

Merchandise database 635 also stores the agreed to conversion rates for each reward program. In one embodiment, there is a plurality of conversion rates for each reward account. For example, one rate may be applied for gold card reward members, another for platinum members and so forth. In another embodiment, the conversion rate is dynamic and is established at the time e-commerce server 110 initiates a redemption transaction.

Shopper interface 610 enables shopper 105 to browse and search merchandise database 635 for desired items of merchandise and service, and purchase desired items on-line. Shopper interface 610 is typically a web interface that provides HTML web pages. Said HTML web pages may be static web pages stored as HTML files or may be generated dynamically in response to shopper requests.

Merchant interface 615 enables merchants to add new items to merchandise database 635, remove old items of merchandise, and modify existing items. Merchant interface 615 enables merchants to view and print database reports about sales of their items of merchandise and service sold through e-commerce server 115.

After shopper 105 makes his/her selection of items, a transaction manager 640 enables shopper 105 to check out, i.e. provide information necessary to complete the order, and review details of the order. If shopper 105 is not a registered shopper, then transaction manager 640 prompts shopper 105 to register with e-commerce server 110. In this case, transaction manager 640 creates a new record in shopper account database 625 for the new shopper.

During checkout, transaction manager 640 enables shopper 105 to provide details about the order including billing, recipient and means of payment information. Transaction manager uses an account manager to request and obtain payment for the order using the means of payment information supplied by shopper 105. If the initial means of payment, e.g. a reward program account, does not pay for the full order then shopper 105 is requested by transaction manager 640 to provide a supplemental means of payment to pay the remaining amount due for the order. This process may continue until the full amount of the order has been received in card funding account 530. Alternatively, shopper 105 may delete one or more items he/she selected in order to reduce the purchase price.

After payment for the order has been received, transaction manager 640 stores a purchase record containing information about the order in purchase database 630. Thus, purchase database 630 stores a record for each order placed by shopper 105.

After payment for the order has been received, transaction manager 640 aggregates the selected items according to merchant 130. Transaction manager 640 then issues orders to each merchant 130 according to the aggregated selected items. Each order includes the virtual credit card information for shopper 105. As previously mentioned, from the perspective of merchant 130, a virtual credit card is the same as a standard credit card, i.e. merchant 130 processes a virtual credit card in the same way that they process a standard credit card. Each merchant 130 ships the selected items indicated in their order to the designated address(es).

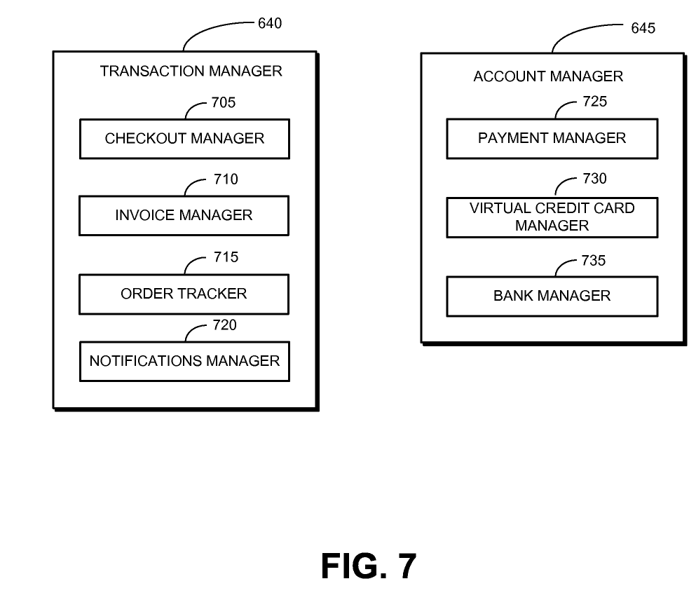

Transaction manager 640 provides shopper 105 with electronic notifications at specified points during a shopping transaction as will be discussed further with reference to FIG. 7.

Account manager 645 processes the means of payment information provided by shopper 105 on behalf of transaction manager 640. Account manager 645 uses the means of payment information to cause shopper payments to be made from reward points system 120 and shopper's bank 125 into the card funding account in payment system bank 115. Account manager 645 further manages the payment and receipt of transaction fees. Account manager 645 tracks payments into and out of the card funding account and any other accounts in payment system bank 115. For each shopper, account manager 645 manages a virtual credit card that is used to make payments to merchants by performing operations including creating, loading, reloading, and closing the virtual credit card. Account manager 645 stores the virtual credit card information with the shopper record in shopper account database 625.

Reference is now made to FIG. 7, which is a simplified block diagram of various components of the e-commerce server illustrated in FIG. 6, in accordance with an embodiment of the present invention. Shown in FIG. 7 are sub-components of transaction manager 640, and account manager 645.

Transaction manager 640 includes a checkout manager 705 for managing the checkout process including obtaining delivery information, payment and billing information. Transaction manager 640 further includes an invoice manager 710 for invoicing shopper 105 based upon his/her selected items, and an order tracker 715 for tracking the items ordered by shopper 105. Finally, transaction manager 640 includes a notifications manager 720 that notifies shopper 105 when inter alia payment has been received and the order is approved, when an item is not available from merchant and shipment will be delayed, when merchant 130 ships an order, and when recipient 140 returns an item and a refund is processed.

Account manager 645 includes a payment manager 725 that manages the process of obtaining payment from inter alia reward points system 120 and shopper's bank 125. Payment manager 725 is capable of redeeming points from a plurality of reward points systems and obtaining payment from credit card network 510 in the case that shopper 105 pays with a credit card. It may be appreciated that payment manager 725 may operate with a wide variety of electronic payment systems.

Account manager 645 further includes a virtual credit card manager 730 that creates a virtual credit card for each order made by shopper 105, unless a virtual credit card already exists for shopper 105. Virtual credit card manager 730 stores information about the order in purchase database 630. Virtual credit card manager 730 is capable of loading, reloading and closing a virtual credit card account.

Account manager 645 further includes a bank manager 735 that manages interactions with payment system bank 115. Bank manager 830 verifies the balances in each of the accounts used by e-commerce server 110 including the card funding account and fee account. Bank manager 735 ensures that all necessary fees are paid to and collected from credit card network 510.

It will be appreciated by those skilled in the art that the systems and methods of the present invention may be implemented within a variety of server-client network architectures. In this regard, reference is now made to FIG. 8, which is a simplified block diagram of an example client-server architecture for implementing a multi-merchant reward points payment system, in accordance with an embodiment of the present invention. On the server side, the architecture in FIG. 8 includes one or more Web application servers 810 managed by load balancers 820, administration servers 830, search servers 840, and three databases. The databases include a transaction database 850 for recording purchase and payment information, including the data from purchase database 630 shown in FIG. 6, a product database 852 for storing product catalog information, including the data from merchandise database 635, and a tracking database 854 for tracking shopper orders and shopper information including shopper account database 625. Web application servers 830 manage transaction database 850, product database 852, tracking database 854, and search servers 840. It may be appreciated by one skilled in the art that Web application servers 830 also act as Web servers in that they accept HTTP requests from Web browsers and serve them HTTP responses along with optional data contents, which usually are web pages such as HTML documents and linked objects (images, etc.). All of these server components are subsumed in e-commerce server computer 115.

On the client side, the architecture shown in FIG. 8 includes shopper 105 using a client computer, merchants 130, and recipient 140 using a client computer. Merchants 130 have two-way connections with administration servers 820. Administration servers 820 send notifications to shopper 105. Thus, the client computers of shopper 105 have one-way connections with administration servers 820. The client computers of shopper 105 have two-way connections with load balancers 810.

Client-server communication is performed over the Internet 860 or other private and/or public communication networks.

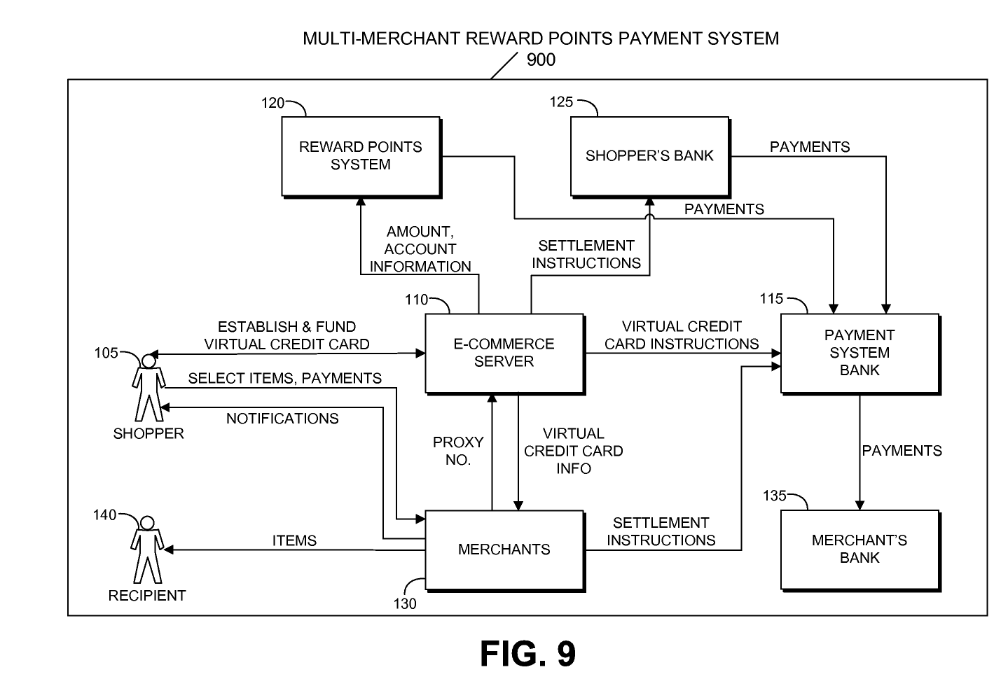

Now reference is made to FIG. 9 which is a simplified block diagram of a multi-merchant reward points payment system that enables a shopper to select items from participating merchant websites and to pay for the items using reward points from a reward program, in accordance with an embodiment of the present invention. Multi-merchant reward points payment system 900 may considered as an alternative embodiment to the system described with respect to FIG. 1. Or, it may be considered as adding new capabilities to the system described with respect to FIG. 1 by enabling shopper 105 to shop directly at the ecommerce websites of merchants 130 that participate in the reward points payment system in addition to shopping at the e-commerce website provided by e-commerce server 110. In this regard, multi-merchant reward points payment system 900 includes additional methods performed by shopper 105, e-commerce server 110, and merchants 130. The other elements of multi-merchant reward points payment system 900 are identical to the corresponding elements in multi-merchant reward points payment system 100. To avoid confusion the numbering of elements in FIG. 9 is identical to that of FIG. 1. Only the new or enhanced methods and capabilities of multi-merchant reward points payment system 900 are discussed hereinbelow.

Merchants 130 that participate in multi-merchant reward points payment system 900 allow shopper 105 to select, order, and pay for items at their respective e-commerce websites using a unique identifier, typically an alphanumeric string, referred to as a “proxy id”, that references a virtual credit card for shopper 105 managed by e-commerce server 110. Initially, shopper 105 establishes and funds a virtual credit card by providing a method of payment to e-commerce server 110 and a funding amount. If no virtual credit card for shopper 105 exists, then e-commerce server 110 establishes and loads a new virtual credit card for shopper 105. If a virtual credit card already exists, then e-commerce server adds to or reloads the virtual credit card amount using the payment method. The payment method includes reward points from a reward program in which shopper 105 has accumulated points, credit card, PAY PAL or other method of payment. After loading or reloading the virtual credit card, in a preferred embodiment, e-commerce server 110 provides shopper 105 with a proxy id that links to the virtual credit card. Shopper 105 may then proceed to shop, order and pay for orders at the e-commerce website of any participating merchant 130 using the proxy id.

A participating merchant 130 enables shopper 105 to use a proxy id as a method of payment as part of the checkout process. Merchant 130 then transmits the proxy id, the shopper's name and potentially other information to e-commerce server 110 for authorization. E-commerce server 110 authenticates the proxy id provided by merchant 130 and in turn provides merchant 130 with the virtual credit card information that corresponds to the proxy id. Merchant 130 then uses the virtual credit card information to obtain payment from shopper 105.

In this embodiment, virtual credit card manager 730 creates, and stores along with other virtual credit card information, a proxy id for each virtual credit card. Upon request, virtual credit card manager 730 provides the proxy id to shopper 105 via shopper interface 610 to enable shopper 105 to pay for items at the e-commerce website of merchant 130.

In another embodiment, virtual credit card manager 730 provides shopper 105, via shopper interface 610, the virtual credit card information; i.e. it provides the virtual credit card information in lieu of a proxy id. In this case, shopper 105 may use the credit card as he/she would use a regular credit card. Shopper 105 may shop, order and pay for items at any e-commerce website; i.e. shopping is not limited to the e-commerce website of a participating merchant 130.

In reading the above description, persons skilled in the art will realize that there are many apparent variations that can be applied to the methods and systems described.

What is claimed is:

1. A method of payment using reward points at a multi-merchant ecommerce website, comprising:
(a) maintaining a merchandise database comprising records for merchandise and services for a plurality of merchants, each record including (i) a stock keeping unit (SKU) for an item of merchandise or service, (ii) a description of the item, (iii) a price of the item, and (iv) the merchant for the item;
(b) enabling a shopper to interactively select one or more items from the merchandise database, thereby generating an aggregated selection of items for each merchant;
(c) enabling said shopper to purchase said one or more items using reward points from a reward program account managed by a reward program manager;
(d) electronically obtaining money from said reward program manager in exchange for said reward points, using an agreed to exchange rate to convert from points to money, and transferring the money into a funding account that is used to pay for purchases by the shopper;
(e) issuing orders to each merchant in accordance with the aggregated selected items corresponding to each merchant; and
(f) paying each merchant the amount of their respective order from the funding account.

2. The method of claim 1 further comprising enabling the shopper to purchase items where the amount of said items is greater than the value of the accumulated reward points in their reward program account by electronically paying the difference between the value of the accumulated reward points and the amount of the items.

3. The method of claim 2 wherein a second reward program account may be used for said electronically paying the difference.

4. The method of claim 2 wherein a credit card may be used for said electronically paying the difference.

5. A system of payment using reward points at a multi-merchant ecommerce website, comprising:
(a) a data storage for maintaining a merchandise database comprising records for merchandise and services for a plurality of merchants, each record including (i) a stock keeping unit (SKU) for an item of merchandise or service, (ii) a description of the item, (iii) a price of the item, and (iv) the merchant for the item;
(b) a shopper interface for enabling a shopper to interactively select one or more items from the merchandise database, thereby generating an aggregated selection of items for each merchant;
(c) an account manager for:
(i) enabling said shopper to pay for said one or more items using reward points from a reward program account managed by a reward program manager; and
(ii) electronically obtaining money from said reward program manager in exchange for said reward points, using an agreed to exchange rate to convert from points to money, and transferring the money into a funding account that is used to pay for purchases by the shopper; and
(d) a transaction manager for issuing orders to each merchant in accordance with the aggregated selected items corresponding to each merchant said orders including means of payment information that enables each merchant to obtain payment for the amount of their respective order from the funding account.

6. The system of claim 5 wherein said transaction manager further enables the shopper to purchase items where the amount of said items is greater than the value of the accumulated reward points in their reward program account by electronically paying the difference between the value of the accumulated reward points and the amount of the items.

7. The system of claim 6 wherein a second reward program account may be used for said electronically paying the difference.

8. The system of claim 6 wherein a credit card may be used for said electronically paying the difference.

9. A computer-readable storage medium storing program code for causing a computing device:
(a) to maintain a merchandise database comprising records for merchandise and services for a plurality of merchants, each record including (i) a stock keeping unit (SKU) for an item of merchandise or service, (ii) a description of the item, (iii) a price of the item, and (iv) the merchant for the item;
(b) to enable a shopper to interactively select one or more items from the merchandise database, thereby generating an aggregated selection of items for each merchant;
(c) to enable said shopper to purchase said one or more items using reward points from a reward program account managed by a reward program manager;
(d) to electronically obtain money from said reward program manager in exchange for said reward points, using an agreed to exchange rate to convert from points to money, and transferring the money into a funding account that is used to pay for purchases by the shopper;
(e) to issue orders to each merchant in accordance with the aggregated selected items corresponding to each merchant; and
(f) to pay each merchant the amount of their respective order from the funding account.

10. A method of payment using reward points at a multi-merchant ecommerce website, comprising:
(a) maintaining a merchandise database comprising records for merchandise and services for a plurality of merchants, each record including (i) a stock keeping unit (SKU) for an item of merchandise or service, (ii) a description of the item, (iii) a price of the item, and (iv) the merchant for the item;
(b) enabling a shopper to interactively select one or more items from the merchandise database, thereby generating an aggregated selection of items for each merchant;
(c) enabling said shopper to purchase said one or more items using points from a reward program account managed by a reward program manager;
(d) electronically obtaining money in exchange for said points from a reward program manager, using an agreed to exchange rate to convert from points to money, and transferring the money into a card funding account that is used to pay for purchases by the shopper;
(e) creating a virtual credit card for said card funding account to enable payment for the items purchased by the shopper using money in the card funding account;
(f) issuing orders to each merchant in accordance with the aggregated selected items corresponding to each merchant; and
(g) providing information about the virtual credit card to each merchant for obtaining payment for the orders issued to the merchant.

11. The method of claim 10 further comprising enabling the shopper to purchase items where the amount of said items is greater than the amount of the accumulated reward points in said reward program account by electronically paying the difference between the amount of the accumulated reward points and the amount of the items.

12. The method of claim 11 wherein a second reward program account may be used for said electronically paying the difference.

13. The method of claim 11 wherein a credit card may be used for said electronically paying the difference.

14. A system of payment using reward points at a multi-merchant ecommerce website, comprising:
(a) a data storage for maintaining a merchandise database comprising records for merchandise and services for a plurality of merchants, each record including (i) a stock keeping unit (SKU) for an item of merchandise or service, (ii) a description of the item, (iii) a price of the item, and (iv) the merchant for the item;
(b) a shopper interface for enabling a shopper to interactively select one or more items from the merchandise database, thereby generating an aggregated selection of items for each merchant;
(c) an account manager for:
(i) enabling said shopper to purchase said one or more items using points from a reward program; and
(ii) electronically obtaining money in exchange for said points from a reward program, using an agreed to exchange rate to convert from points to money, and transferring the money into a card funding account that is used to pay for purchases by the shopper; and
(iii) creating a virtual credit card account for said purchase to enable payment for the items purchased by the shopper; and
(d) a transaction manager for issuing orders to each merchant in accordance with the aggregated selected items corresponding to each merchant, said orders including virtual credit card information that enables each merchant to obtain payment for the amount of their respective order.

15. The system of claim 14 wherein said transaction manager further enables the shopper to purchase items where the amount of said items is greater than the value of the accumulated reward points in their reward program account by electronically paying the difference between the value of the accumulated reward points and the amount of the items.

16. The system of claim 15 wherein a second reward program account may be used for said electronically paying the difference.

17. The system of claim 15 wherein a credit card may be used for said electronically paying the difference.

18. A computer-readable storage medium storing program code for causing a computing device:
(a) to maintain a merchandise database comprising records for merchandise and services for a plurality of merchants, each record including (i) a stock keeping unit (SKU) for an item of merchandise or service, (ii) a description of the item, (iii) a price of the item, and (iv) the merchant for the item;
(b) to enable a shopper to interactively select one or more items from the merchandise database, thereby generating an aggregated selection of items for each merchant;
(c) to enable said shopper to purchase said one or more items using points from a reward program account managed by a reward program manager;
(d) to electronically obtain money in exchange for said points from a reward program manager, using an agreed to exchange rate to convert from points to money, and transferring the money into a card funding account that is used to pay for purchases by the shopper;
(e) to create a virtual credit card for said card funding account to enable payment for the items purchased by the shopper using money in the card funding account;
(f) to issue orders to each merchant in accordance with the aggregated selected items corresponding to each merchant; and
(g) to provide information about the virtual credit card to each merchant for obtaining payment for the orders issued to the merchant.

19. A method of electronic payment using reward points, comprising:
(a) enabling a shopper to interactively specify a number of reward points to be withdrawn from a reward account provided by a reward program manager;
(b) electronically requesting that said program manager redeem said number of reward points from said reward account;
(c) redeeming by said program manager said number of reward points from said reward account by electronically transferring a corresponding amount of money, using an agreed to exchange rate to convert from points to money, into a card funding account that is used to pay for purchases by the shopper;
(d) creating a virtual credit card for said card funding account to enable payment for the items purchased by the shopper using money in the card funding account;
(e) providing to the shopper a unique shopper identifier that links to said virtual credit card to be used for purchases of items at merchants' e-commerce websites;
(f) enabling the shopper to interactively select one or more items from one or more merchants' e-commerce websites;
(g) enabling the shopper to provide said unique shopper identifier as a means of payment to the merchants' e-commerce websites;
(h) enabling each merchant to request information about the virtual credit card that corresponds to said unique shopper identifier; and
(i) providing said information about the virtual credit to each merchant for obtaining payment for the shopper's purchases.

20. The method of claim 19 further comprising enabling said shopper to interactively specify an additional method of payment to be used to reload the virtual credit card with a specified amount.

21. The method of claim 20 wherein said additional method of payment may be a second reward program account.

21. The method of claim 20 wherein said additional method of payment may be a credit card.

22. A system of electronic payment using reward points, comprising:
(a) a shopper interface for enabling a shopper to interactively specify a number of reward points to be withdrawn from a reward account provided by a reward program manager;
(b) a payment manager for electronically requesting that said program manager redeem said number of reward points from said reward account;
(c) a program manager for redeeming said number of reward points from said reward account by electronically transferring a corresponding amount of money, using an agreed to exchange rate to convert from points to money, into a card funding account that is used to pay for purchases by the shopper;
(d) a virtual credit card manager for:
(i) creating a virtual credit card for said card funding account to enable payment for the items purchased by the shopper using money in the card funding account; and
(ii) providing to the shopper a unique shopper identifier that links to said virtual credit card to be used for purchases of items at merchants' e-commerce websites;
(e) a merchant's e-commerce website for:
(i) enabling the shopper to interactively select one or more items to purchase;
(ii) enabling the shopper to provide said unique shopper identifier as a means of payment for said items; and
(iii) enabling each merchant to request information about the virtual credit card that corresponds to said unique shopper identifier; and
(f) a merchant interface for providing said information about the virtual credit to each merchant for obtaining payment for the shopper's purchases.

23. The system of claim 22 further comprising enabling said shopper to interactively specify an additional method of payment to be used to reload the virtual credit card with a specified amount.

24. The system of claim 23 wherein said additional method of payment may be a second reward program account.

25. The system of claim 23 wherein said additional method of payment may be a credit card.

26. A computer-readable storage medium storing program code for causing a computing device:
(a) enabling a shopper to interactively specify a number of reward points to be withdrawn from a reward account provided by a reward program manager;
(b) electronically requesting that said program manager redeem said number of reward points from said reward account;
(c) redeeming by said program manager said number of reward points from said reward account by electronically transferring a corresponding amount of money, using an agreed to exchange rate to convert from points to money, into a card funding account that is used to pay for purchases by the shopper;
(d) creating a virtual credit card that can be used by the shopper to pay for items using money from the card funding account;
(e) providing to the shopper a unique shopper identifier that links to said virtual credit card to be used for purchases of items at merchants' e-commerce websites;
(f) enabling the shopper to interactively select one or more items from one or more merchants' e-commerce websites;
(g) enabling the shopper to provide said unique shopper identifier as a means of payment to the merchants' e-commerce websites;
(h) enabling each merchant to request information about the virtual credit card that corresponds to said unique shopper identifier;
(i) providing said information about the virtual credit to each merchant for obtaining payment for the shopper's purchases.

27. A method of electronic payment using reward points, comprising:
(a) enabling a shopper to interactively specify a number of reward points to be withdrawn from a reward account provided by a reward program manager;
(b) electronically requesting that said program manager redeem said number of reward points from said reward account;
(c) redeeming by said program manager said number of reward points from said reward account by electronically transferring a corresponding amount of money, using an agreed to exchange rate to convert from points to money, into a card funding account that is used to pay for purchases by the shopper;
(d) creating a virtual credit card that can be used by the shopper to pay for items using money from the card funding account;
(e) providing to the shopper information about said virtual credit card to be used to pay for items at merchants' e-commerce websites;
(f) enabling the shopper to interactively select one or more items from one or more merchants' e-commerce websites; and
(g) enabling the shopper to provide said information about said virtual credit card to pay for said items.

28. The method of claim 27 further comprising enabling said shopper to interactively specify an additional method of payment to be used to reload the virtual credit card with a specified amount.

29. The method of claim 28 wherein said additional method of payment may be a second reward program account.

30. The method of claim 28 wherein said additional method of payment may be a credit card.

31. A system of electronic payment using reward points, comprising:
(a) a shopper interface for enabling a shopper to interactively specify a number of reward points to be withdrawn from a reward account provided by a reward program manager;
(b) a payment manager for electronically requesting that said program manager redeem said number of reward points from said reward account;
(c) a program manager for redeeming said number of reward points from said reward account by electronically transferring a corresponding amount of money, using an agreed to exchange rate to convert from points to money, into a card funding account that is used to pay for purchases by the shopper;
(d) a virtual credit card manager for:
(i) creating a virtual credit card that can be used by the shopper to pay for items using money from the card funding account; and
(ii) providing to the shopper information about said virtual credit card to be used to pay for items at merchants' e-commerce websites; and
(e) a merchant's e-commerce website for:
(i) enabling the shopper to interactively select one or more items; and
(ii) enabling the shopper to provide said information about said virtual credit card to pay for said items.

32. The system of claim 31 further comprising enabling said shopper to interactively specify an additional method of payment to be used to reload the virtual credit card with a specified amount.

33. The system of claim 32 wherein said additional method of payment may be a second reward program account.

34. The system of claim 32 wherein said additional method of payment may be a credit card.

35. A computer-readable storage medium storing program code for causing a computing device:
(a) to enable a shopper to interactively specify a number of reward points to be withdrawn from a reward account provided by a reward program manager;
(b) to electronically request that said program manager redeem said number of reward points from said reward account;
(c) to redeem by said program manager said number of reward points from said reward account by electronically transferring a corresponding amount of money, using an agreed to exchange rate to convert from points to money, into a card funding account that is used to pay for purchases by the shopper;
(d) to create a virtual credit card that can be used by the shopper to pay for items using money from the card funding account;
(e) to provide to the shopper information about said virtual credit card to be used to pay for items at merchants' e-commerce websites;
(f) to enable the shopper to interactively select one or more items from one or more merchants' e-commerce websites; and
(g) to enable the shopper to provide said information about said virtual credit card to pay for said items.
